(19) United States
(12) Patent Application Publication
(10) Pub. No.: US 2016/0092866 A1
(43) Pub. Date: Mar. 31, 2016

(54) PROVIDING FRICTIONLESS PUSH PAYMENTS

(71) Applicant: MOZIDO, INC., Austin, TX (US)

(72) Inventors: Michael A. Liberty, Orlando, FL (US); Mike Love, Austin, TX (US); Steve Bacastow, Cumming, GA (US); Robert Sadeckas, Brecksville, OH (US); David Michael Cook, Round Rock, TX (US)

(21) Appl. No.: 14/868,231

(22) Filed: Sep. 28, 2015

Related U.S. Application Data
(60) Provisional application No. 62/057,132, filed on Sep. 29, 2014.

(51) Int. Cl. G06Q 20/36; G06Q 20/40; G06Q 20/42; G06Q 20/32

(52) U.S. Cl. CPC G06Q 20/363; G06Q 20/3224; G06Q 20/401; G06Q 20/42

(57) ABSTRACT

A computer system is provided which determines that a mobile device associated with an identified customer is within a seller's store. The computer system further receives transaction information from a mobile wallet application associated with the customer which includes an indication of items that are to be purchased, an indication of the amount that is to be paid, and an indication that payment is to be made from a stored value account (SVA) associated with the customer. The computer system determines, based on the customer's identity, current location, and the received transaction information, that the customer has approved the transaction, processes the transaction using the customer's SVA, provides a credit to the seller in the amount debited from the customer's SVA and generates an electronic receipt for the customer, notifying the customer that the seller has received the specified amount of money from the customer's SVA.

### RELATED APPLICATIONS

This application claims priority to and the benefit of U.S. Provisional Patent Application Ser. No. 62/057,132, entitled “Providing Push Payments in a Mobile Transaction System”, filed on Sep. 29, 2014, which application is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Today's smart phones use software applications to perform a wide variety of functionality. In some cases, this functionality may include the ability to pay for items using a mobile payment system. Such a mobile payment system may allow users to pay for items at a store or over the internet using their phone.

Mobile payment applications can be deployed to smart phones to enable consumers to pay for goods and services using their phone in lieu of cash or credit cards. These mobile payment applications may be provided by a smart phone manufacturer such as Apple or Samsung, offered by a bank, or in some cases they may be offered by a retailer such as a Quick Service Restaurant (QSR).

In fact, a large number of QSRs have already developed and deployed at least one version of a mobile payment application for their retail customers. Some QSRs have developed multiple different mobile payment applications and often through trial and error, have experienced difficulty getting consumers to adopt the technology. For instance, some retail locations have set up bar code scanners or quick response (QR) code scanners to assist in the customer checkout experience. Others have installed near field communication (NFC) or other devices for similar reasons. Each installation takes time and money, and may be a wasted expense if there is a shortage of customer adoption or if the technology changes and becomes obsolete. Thus, previous solutions share a common shortcoming that requires some sort of friction between the consumer and a device of the merchant wherein the consumer is required.

The user interface and user experience are key factors in consumer adoption and should be carefully considered when designing, developing and deploying a mobile payment application. Other factors that can drive consumer adoption of a new technology such as a mobile payment application include incentives such as coupons and loyalty.

### BRIEF SUMMARY

Embodiments described herein provide methods and systems that facilitate a desirable mobile payment and loyalty user experience that fosters consumer adoption for retailers (such as QSRs) that adopt the technology.

In one embodiment, a mobile application enables a series of consumer and store employee interactions using the mobile device of the consumer and a tablet device of the retailer for payment processing using a stored value account (SVA).

In another embodiment, a mobile application enables a series of consumer and store employee interactions using the mobile device of the consumer and a tablet device of the retailer for payment processing where a promotional offer in the form of a mobile coupon is also redeemed by the consumer.

In another embodiment, a mobile application enables a series of consumer and store employee interactions using the mobile device of the consumer and a tablet device of the retailer for payment processing where a reward is also redeemed by the consumer.

In another embodiment, a mobile application enables a series of consumer and store employee interactions using the mobile device of the consumer and a tablet device of the retailer where loyalty points are earned by the consumer.

In another embodiment, a mobile application enables a series of consumer and store employee interactions using the mobile device of the consumer and a tablet device of the retailer where an offer is redeemed by the consumer.

In another embodiment, a mobile application enables a series of consumer and store employee interactions using the mobile device of the consumer and a tablet device of the retailer where customers may accrue loyalty or rewards points over time and later convert them into price discount.

In another embodiment, a computer system is provided which includes a mobile device location identifier configured to determine that a mobile device associated with an identified customer is within a specific geographic location corresponding to a seller's store. The computer system further includes a receiver configured to receive transaction information from a mobile wallet application associated with the customer. The transaction information includes an indication of items that are to be purchased, an indication of the amount that is to be paid, and an indication that payment is to be made from a stored value account (SVA) associated with the customer.

The computer system also includes a transaction processor that is configured to perform the following: determine, based on the identity of the customer, the customer's current location, and the received transaction information, that the customer has approved the transaction, process the transaction using the received transaction information, such that the indicated amount that is to be paid is debited from the customer's SVA, provide a credit to the seller in the amount debited from the customer's SVA and generate an electronic receipt for the customer, notifying the customer that the seller has received the specified amount of money from the customer's SVA.

In another embodiment, a computer system is provided which includes one or more processors and a display. The display provides a user interface (UI) that includes the following: a first button that, when selected, initiates a transaction with a mobile payment platform. The transaction initiation includes transmitting transaction information to the mobile payment platform including an indication of items that are to be purchased, an indication of the amount that is to be paid, an indication of a customer's current location, and an indication that payment is to be made from a stored value account (SVA) associated with the customer. The UI further includes a second button that, when selected, applies a coupon, an offer or rewards points to reduce the amount of the transaction.

The UI also includes a third button that, when selected, confirms that the transaction amount is to be debited from the customer's SVA upon the mobile payment platform determining, based on the identity of the customer, the customer's current location, and the received transaction information, that the customer has approved the transaction. The UI further includes a graphical indicator indicating that the transaction is currently being processed, and an electronic receipt indicating that the transaction amount was debited from the user's stored value account.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a system architecture for a mobile wallet platform.

FIG. 2 illustrates an example wherein a customer can perform a transaction using a stored value account (SVA).

FIG. 3 illustrates an example wherein a customer can perform a transaction that involves a mobile coupon.

FIG. 4 illustrates an example wherein users can redeem a reward using loyalty points in conjunction with a payment.

FIG. 5 illustrates an example wherein customers may be able to receive loyalty points for simply being in the store.

FIG. 6 illustrates an example wherein a customer uses a mobile offer in their mobile wallet application.

FIG. 7 illustrates an example wherein customers may redeem a reward using loyalty points without making a payment.

FIG. 8 illustrates an end-to-end sequence flow of an example use case of a consumer interaction using a mobile device.

FIG. 9 illustrates a computing environment in which embodiments described herein may be performed including performing a transaction using a SVA.

FIG. 10 illustrates a flowchart of a method for performing a transaction suing a SVA.

FIG. 11 illustrates an embodiment of a user interface provided as part of a mobile wallet application.

### DETAILED DESCRIPTION

In one embodiment, a computer system is provided which includes the following: a mobile device location identifier configured to determine that a mobile device associated with an identified customer is within a specific geographic location corresponding to a seller's store. The computer system further includes a receiver configured to receive transaction information from a mobile wallet application associated with the customer. The transaction information includes an indication of items that are to be purchased, an indication of the amount that is to be paid, and an indication that payment is to be made from a stored value account (SVA) associated with the customer.

The computer system also includes a transaction processor that is configured to perform the following: determine, based on the identity of the customer, the customer's current location, and the received transaction information, that the customer has approved the transaction, process the transaction using the received transaction information, such that the indicated amount that is to be paid is debited from the customer's SVA, provide a credit to the seller in the amount debited from the customer's SVA and generate an electronic receipt for the customer, notifying the customer that the seller has received the specified amount of money from the customer's SVA.

In another embodiment, a computer system is provided which includes one or more processors and a display. The display provides a user interface (UI) that includes the following: a first button that, when selected, initiates a transaction with a mobile payment platform. The transaction initiation includes transmitting transaction information to the mobile payment platform including an indication of items that are to be purchased, an indication of the amount that is to be paid, an indication a customer's current location, and an indication that payment is to be made from a stored value account (SVA) associated with the customer. The UI further includes a second button that, when selected, applies a coupon, an offer or rewards points to reduce the amount of the transaction.

The UI also includes a third button that, when selected, confirms that the transaction amount is to be debited from the customer's SVA upon the mobile payment platform determining, based on the identity of the customer, the customer's current location, and the received transaction information, that the customer has approved the transaction. The UI further includes a graphical indicator indicating that the transaction is currently being processed, and an electronic receipt indicating that the transaction amount was debited from the user's stored value account.

The following discussion refers to a number of methods and method acts that may be performed by one or more embodiments of the subject matter disclosed herein. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be mobile phones, electronic appliances, laptop computers, tablet computers, wearable devices, desktop computers, mainframes, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

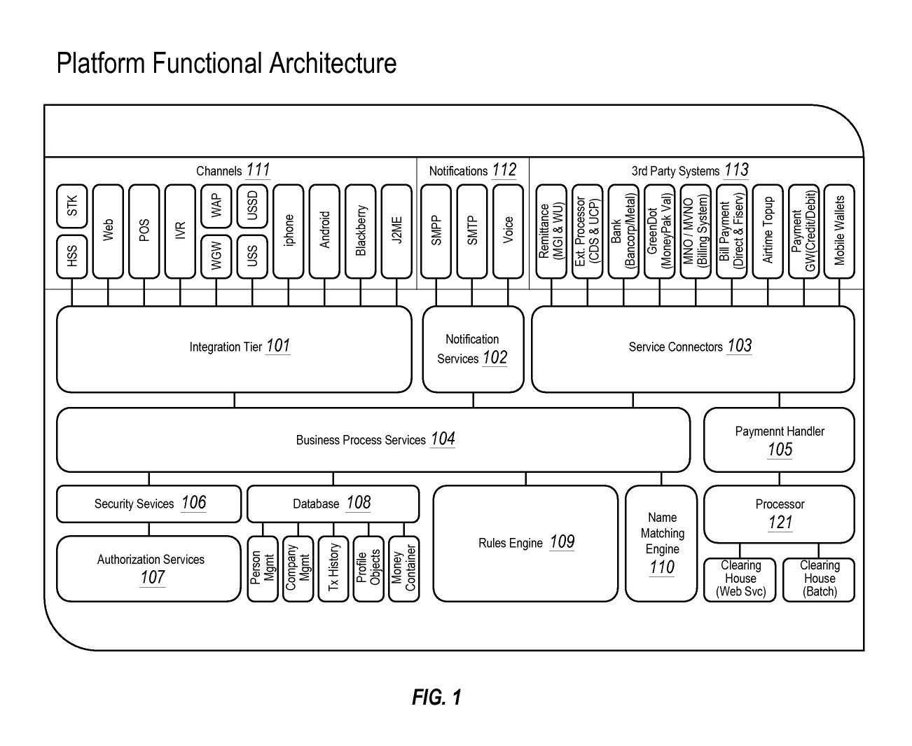

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be used to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

Embodiments described herein provide customers, through the use of their mobile phone, a mobile wallet application allowing them to check-in, receive offers, load cash, and make payments. In some cases, the mobile wallet application may be specific to a certain restaurant, store or other place of business. For example, in the Figures and in the description below, a QSR restaurant is used as an example point of sale, although substantially any place of business or other establishment may be used. The application may run on any of a wide variety of existing and future mobile phones, tablets, wearable devices, laptops or other computer systems. Many different security measures may be implemented for each user's account, including specific login IDs and passwords, two-factor authentication, biometric credentials or other security measures.

The user may also be asked to create a Personal Identification Number (PIN) or other authentication credential in order to authorize certain transactions. Transactions made through the application (or “app” herein) that require a credit card are secured by requiring a PIN, a security code on the back of a credit card, or other credential. These two numbers are not saved and, at least in some embodiments, will be requested each transaction to confirm the credit card transaction.

Cashiers may also be able to make transactions through WiFi communications with the customer's mobile application. These transactions can include mobile payments, redeeming coupons, and/or claiming loyalty rewards. Cashiers may also be able to cancel transactions and make refunds, all using a tablet or other electronic device.

In order to navigate and perform functions within the mobile wallet application, a user such as a cashier, manager or end user first logs in to a monetary transaction system (e.g. the mobile wallet platform of FIG. 1). Logging into the mobile wallet platform may involve a mobile number and a password. In addition, a PIN or other credential may be required to complete any financial transaction.

At least in some embodiments, no transaction fees are involved for any of the transactions performed. In other cases, transaction fees may be implemented on a per-transaction basis. Users may be able to add more money to their account if they don't have enough to cover a transaction. User's credit card information is typically not stored on their phone; however, users will have the option to save the credit card information to their mobile wallet account if desired. In this case, the card information is securely stored on a remote cloud server and a tokenized value is returned to the phone and associated with the payment account number. Users can top off their store-specific accounts using MasterCard, Visa, American Express, Discover or other credit or debit cards. The funding account may be a stored value account similar to a gift card.

Users can earn rewards each time they make a purchase, or redeem a coupon. Rewards may be cashed in immediately, or the user may accumulate their rewards (e.g. loyalty points) and use them at a different time. In some cases, users may receive rewards simply for checking in at a store. Coupons may be provided by the headquarters or by the stores themselves, and may be updated over time. Reward points are earned when users make purchases or redeem coupons or check in to a location.

Some embodiments may also implement special types of offer points or other offers that are automatically downloaded to a user's mobile wallet application. Redemption rules may also be presented alongside the rewards or offers. Once a user has authenticated to their mobile wallet application, the user's available offers will be displayed from their favorite local and national stores. Offers may be updated each time the user logs in.

In some cases, stores may allow redemption of multiple coupons during the same visit, while other stores may only allow one coupon per visit. Each store may implement its own policies for coupon/reward redemption. In some embodiments, the store-specific mobile wallet application may provide a map that shows the location of nearby stores, and may further show the locations of stores that allow payment by mobile wallet. The store-specific mobile wallet application thus allows users to pay for items or services sold by the store, view the user's current store-specific account balance, receive promotional coupons from their favorite stores, cash in mobile coupons, recharge their account using credit or debit cards, find a retailer's closest store on a map, top up the user's stored value account (SVA) with that retailer, pay for items or services using their SVA account, apply coupons, offers, points, rewards or other promotions to their purchase to lower the purchase price, or perform other tasks.

Such embodiments allow customer-to-merchant payments by means of a mobile device. The transaction may be initialized by the customer's geo-targeted check-in into the store. Indeed, as will be further described below, a user may check in to a certain store location simply by opening their store-specific (or generic) mobile wallet application within a specified geographic area around the store. By checking in, the customer allows the cashiers to select the customer and bill them for any provided goods or services. The user can confirm payment from their SVA, and their SVA will be debited for the indicated amount. As customers purchase items through their mobile wallet application, they may receive loyalty points from a certain store, or points that transfer to other national chain stores of the same brand (or the same family of brands).

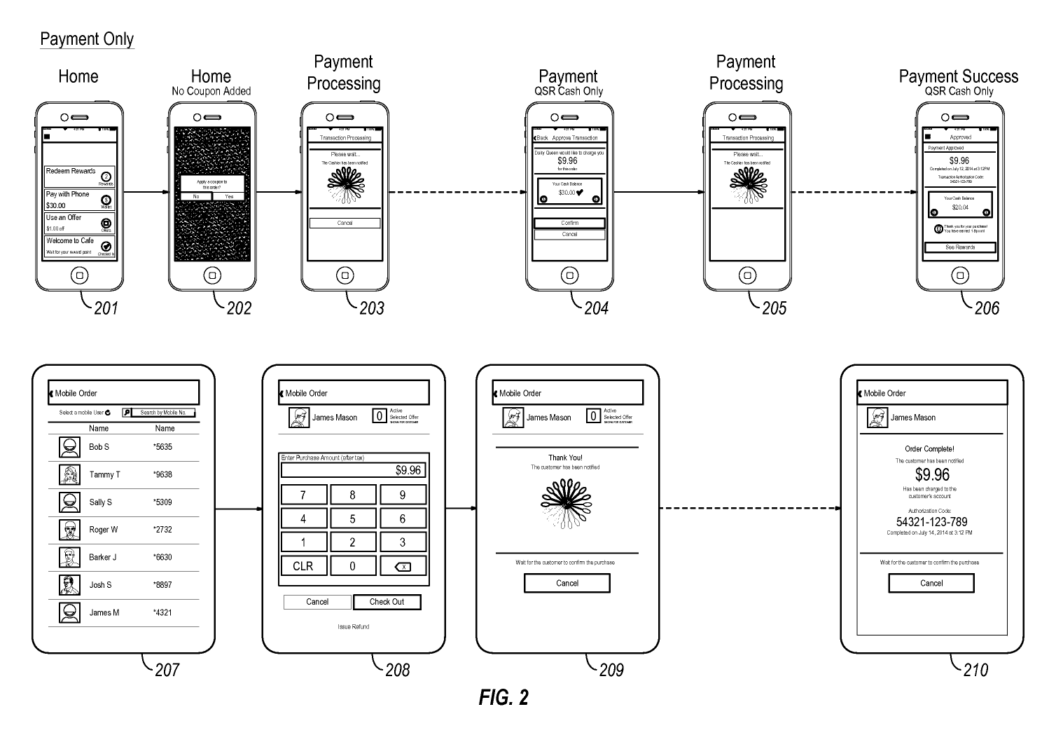

In the illustration of FIG. 2, a customer can perform a payment transaction using a stored value account (SVA). In this example use case, the consumer enters a QSR location with registered geo coordinates. The mobile device of the consumer is comprised of the QSR mobile payment application. The mobile payment application uses the geo services of the mobile device to determine the current location of the user and use the current location to check into the store that corresponds to the registered geo coordinates. As soon as the consumer (James M.) is recognized by the system as being within the geo coordinates of the registered QSR location, the system is operable to refresh a display of checked in consumers on a tablet device of the merchant as shown using UI 207.

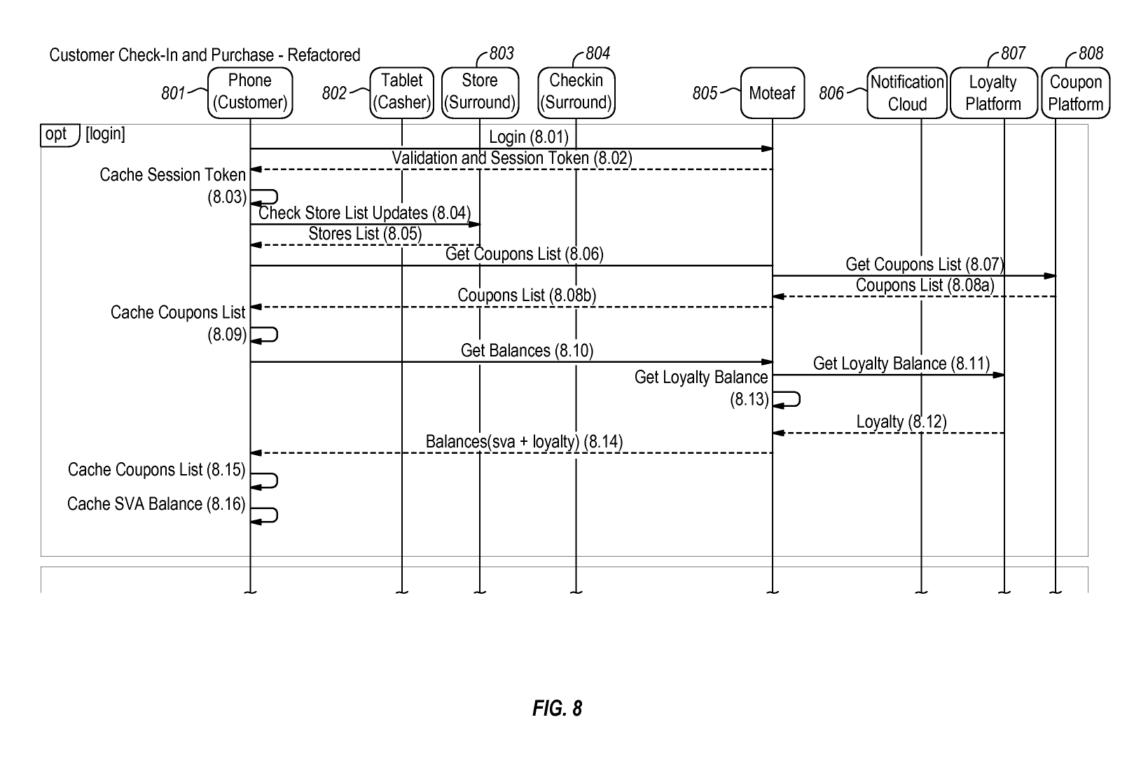

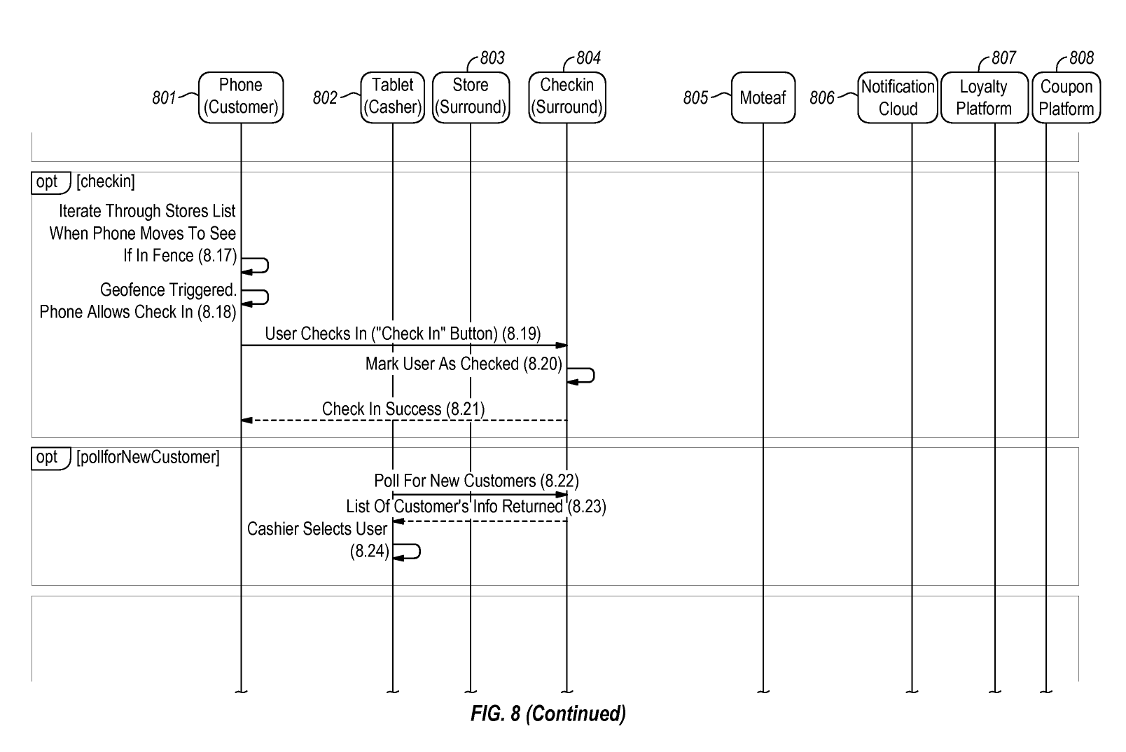

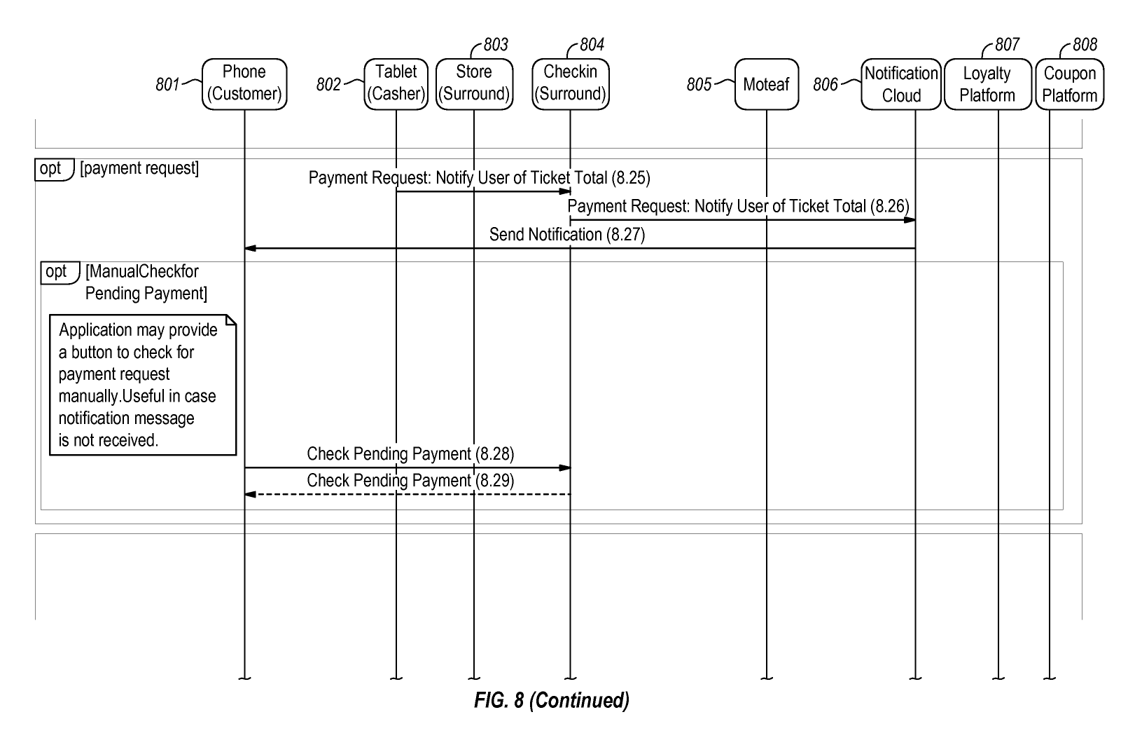

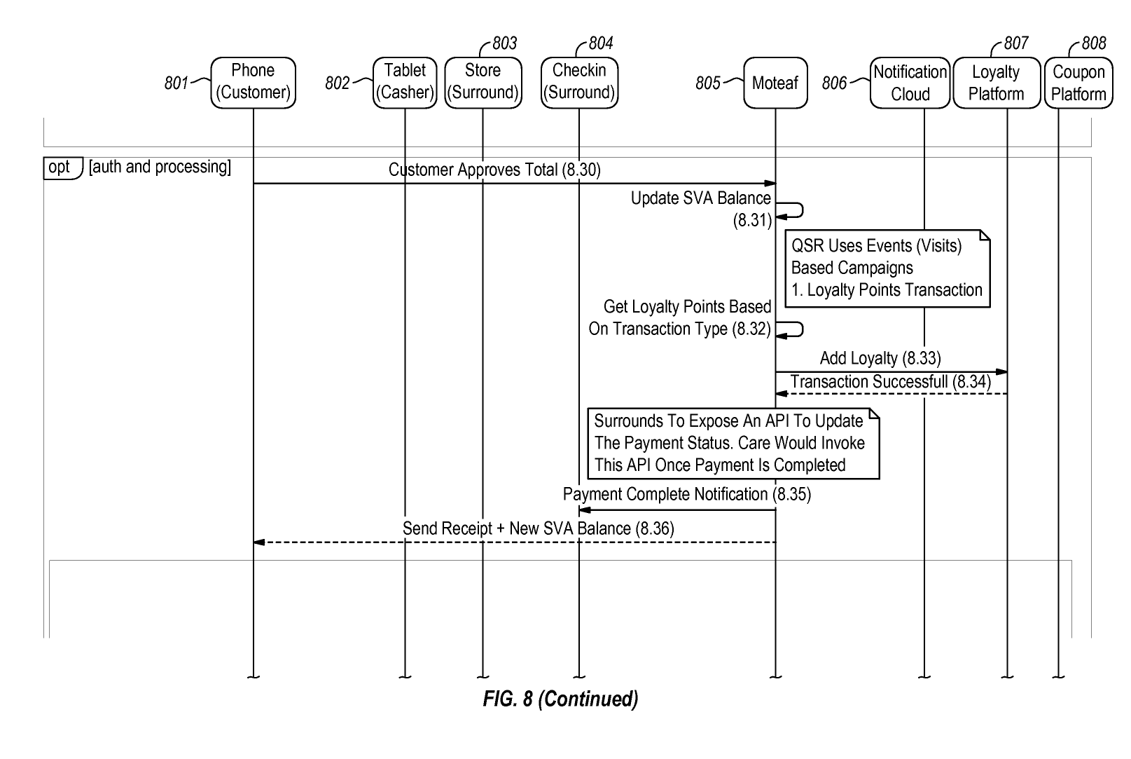

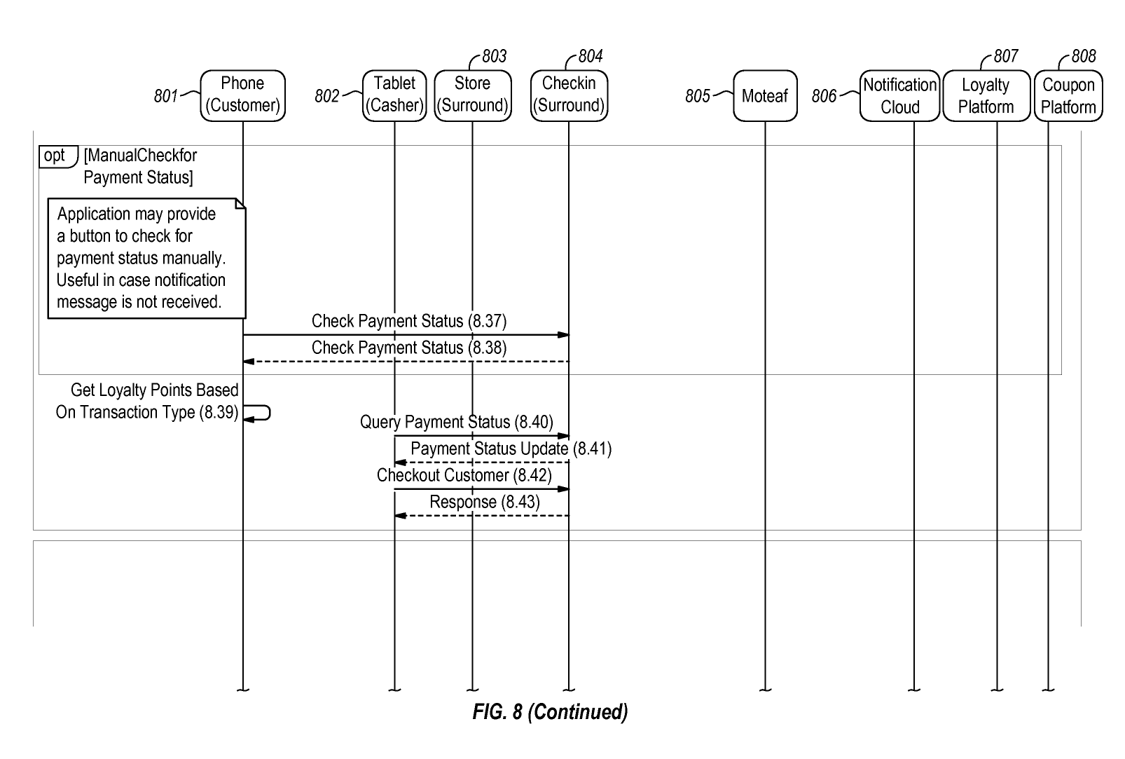

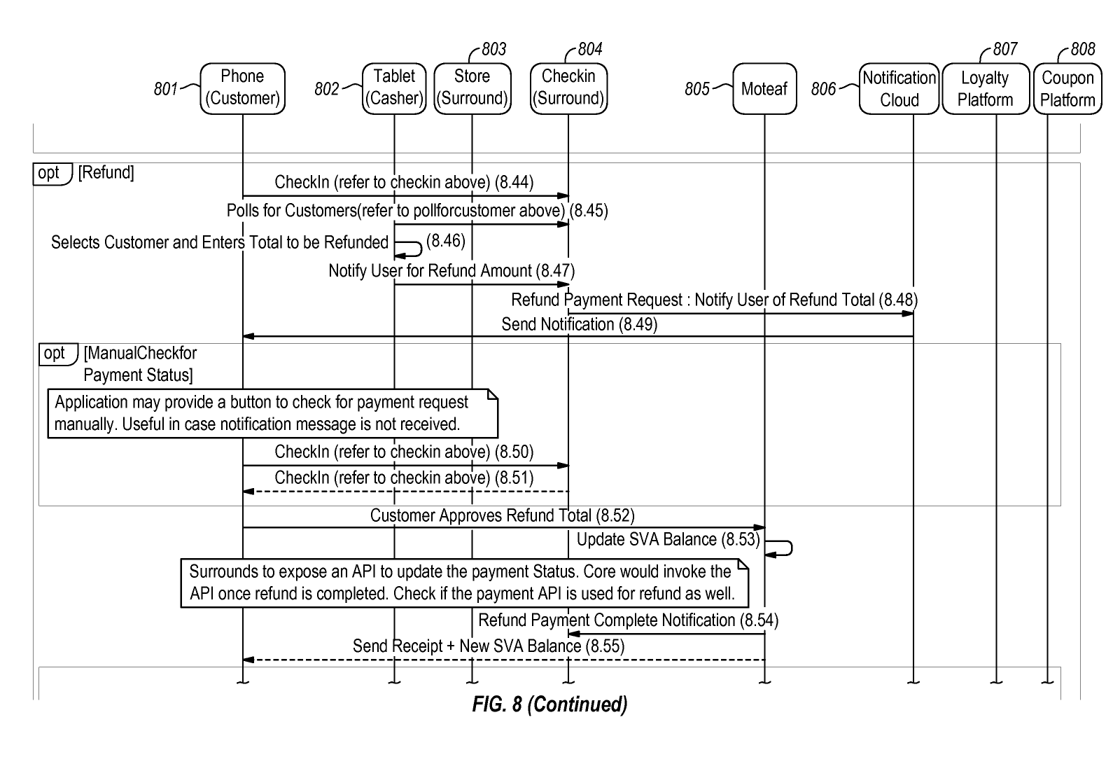

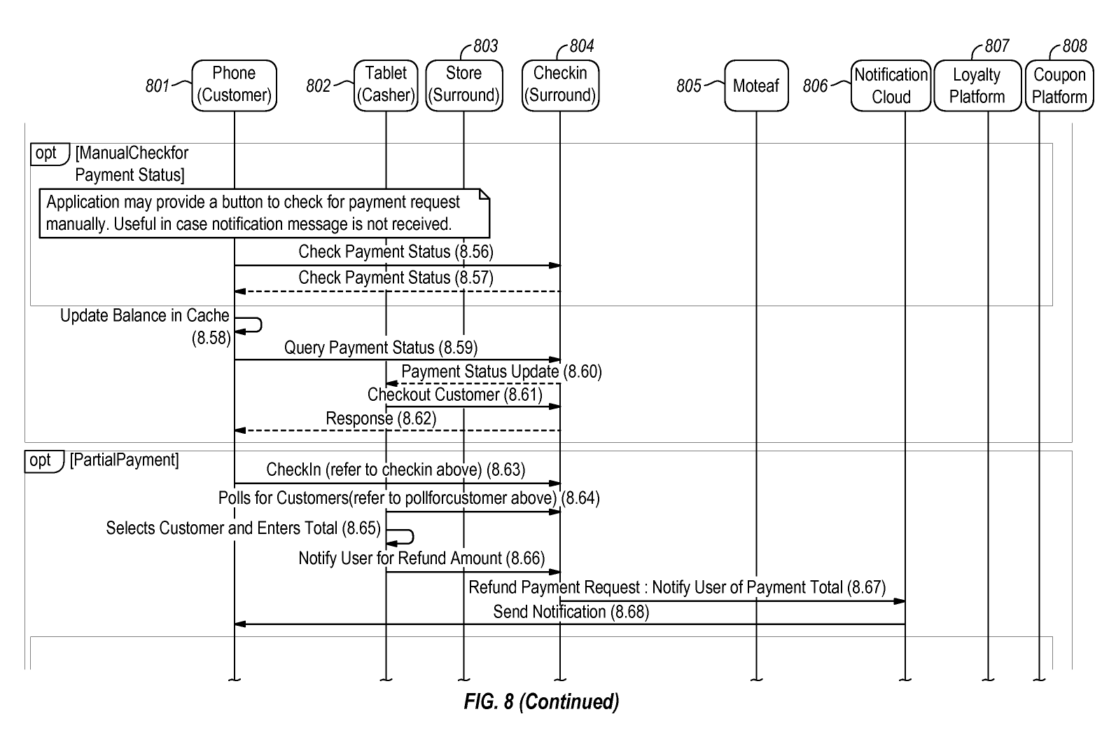

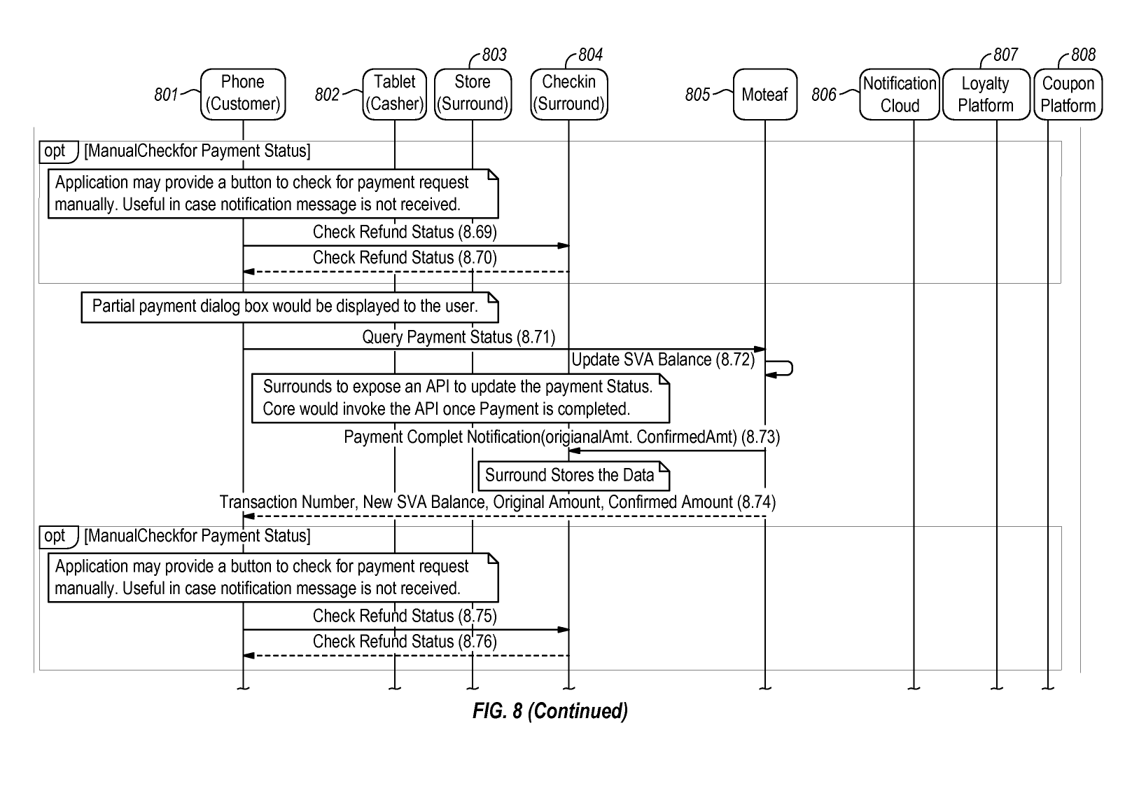

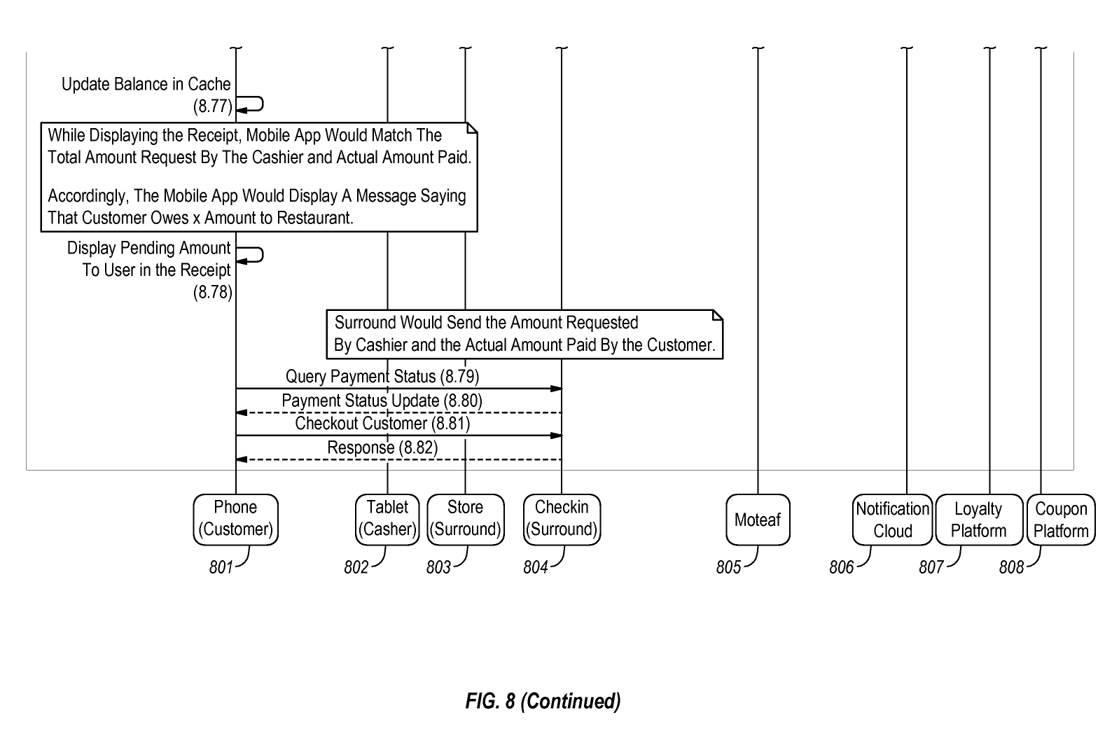

Using user interface UI 201, the user is presented with various options including: redeem rewards, pay with phone, use an offer, or wait for your reward point. In this example use case the customer selects the ‘pay with phone’ option. The system is operable to ask the consumer if they would like to apply a coupon to the current order. In this example use case, the consumer declines by selecting ‘no’ on the presented UI 202. Responsive to the input of the consumer, the system is operable to render UI 203 on the mobile device of the consumer. Control is now passed to the tablet device of the merchant. Note that the passing of control from the mobile device of the consumer to the tablet device of the merchant is more fully described in FIG. 8 as an embodiment of the Checkin Surround 804 system acting as a state machine that is operable to track all of the interactions between a plurality of consumers and merchants. The employee of merchant selects “James M.” from the display on UI 207 which causes the system to render UI 208 on the tablet. Using UI 208, the employee of the merchant enters the tender amount ($9.96) of the purchase. It should be noted that, in some embodiments, the system is operable to automatically determine the tender amount owed through an optional interface with the primary store order management platform.

The employee of the merchant continues the process by selecting the “Checkout” option on UI 208. Responsive to the input on the tablet device, the system is operable to render UI 204 on the mobile device of the consumer. UI 204 displays the tender amount and the consumer's current SVA balance. The consumer can either cancel or confirm the order. In this example use case, the user confirms the order using UI 204. Responsive to the input of the consumer, the system is operable to deduct the tender amount from the SVA available balance. During payment processing the system is operable to render UI 205 on the mobile device of the consumer.

After payment processing is complete, the system is operable to render UI 206 on the mobile device of the consumer and render UI 210 on the tablet device of the merchant. Both UIs indicating that the transaction is complete. UI 206 also provides an indication of the new available balance of the SVA account of the consumer. It is thus an advantage of the system to provide a frictionless in store payment process flow using the mobile device of the consumer and the tablet device of the merchant without requiring an additional scanning device at the merchant location.

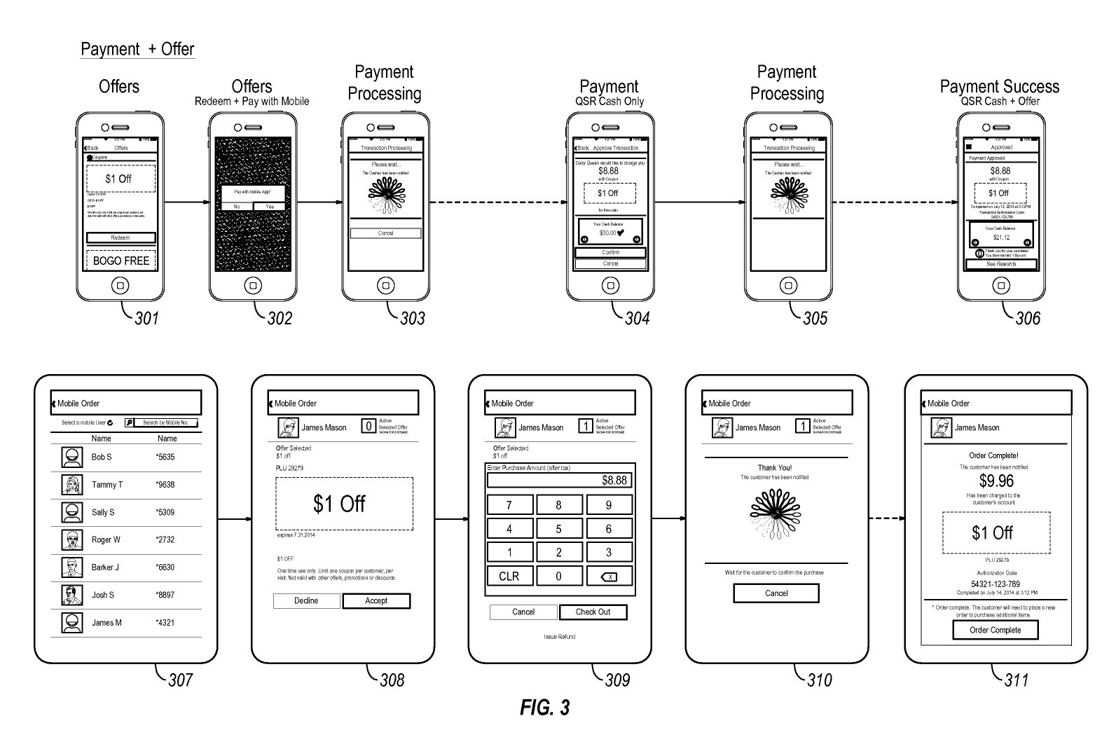

In FIG. 3, a customer can perform a transaction that involves a mobile offer (e.g. coupon). The mobile offer allows the customer to apply direct discounts to the transaction using their mobile device. The offer can be applied simply by pressing a button within the mobile wallet application. Once the transaction amount has been lowered by the amount specified in the offer, the remainder can be debited from the customer's SVA. In this example use case, the consumer enters a retailer's location (e.g. a QSR location) with registered geo coordinates. The mobile device of the consumer is comprised of the QSR mobile payment application. The mobile payment application uses the geo services of the mobile device to determine the current location of the user and use the current location to check into the store that corresponds to the registered geo coordinates.

As soon as the consumer (James M.) is recognized by the system as being within the geo coordinates of the registered QSR location, the system is operable to refresh a display of checked in consumers on a tablet device of the merchant as shown using UI 307. Referring back to FIG. 2 and using user interface UI 201, the user is presented with various options including: redeem rewards, pay with phone, use an offer, or wait for your reward point. In this example use case the customer selects the ‘use an offer’ option. Responsive to the input of the consumer, the system is operable to render UI 301 on the mobile device of the consumer.

In this example use case, the consumer selects the “redeem” option of the rendered UI 301 causing the system to render UI 302. The system is operable to ask the consumer if they would like to ‘pay with mobile’ for the current order. In this example use case, the consumer agrees to pay with mobile by selecting ‘yes’ on the rendered UI 302. Responsive to the input of the consumer, the system is operable to render UI 303 on the mobile device of the consumer. Control is now passed to the tablet (or other computing) device of the merchant. Note that the passing of control from the mobile device of the consumer to the tablet device of the merchant is more fully described in FIG. 8 as an embodiment of the Checkin Surround 804 system acting as a state machine that is operable to track all of the interactions between a plurality of consumers and merchants. The employee of merchant selects “James M.” from the display on UI 307 which causes the system to render UI 308 on the tablet. Using UI 308, the employee of the merchant “accepts” the offer presented from the mobile device of the consumer.

Next, using UI 309, the employee of the merchant enters the net tender amount ($8.88) of the purchase. It should be noted that, in some embodiments, the system is operable to automatically determine the net tender amount owed through an optional interface with the primary store order management platform. The employee of the merchant continues the process by selecting the “Checkout” option on UI 309. Responsive to the input on the tablet device, the system is operable to render UI 304 on the mobile device of the consumer. UI 304 displays the net tender amount after applying the value of the offer and the consumer's current SVA balance. The consumer can either cancel or confirm the order.

In this example use case, the user confirms the order using UI 304. Responsive to the input of the consumer, the system is operable to deduct the tender amount from the SVA available balance and remove the offer from the list of available offers for this consumer. During payment processing the system is operable to render UI 305 on the mobile device of the consumer and UI 310 on the tablet device of the merchant, both UIs indicting that payment processing is under way. After payment processing is complete, the system is operable to render UI 306 on the mobile device of the consumer and render UI 311 on the tablet device of the merchant. Both UIs indicating that the transaction is complete. UI 306 also provides an indication of the new available balance of the SVA account of the consumer. It is thus an advantage of the system to provide a frictionless in store payment process using an offer using the mobile device of the consumer and the tablet device of the merchant.

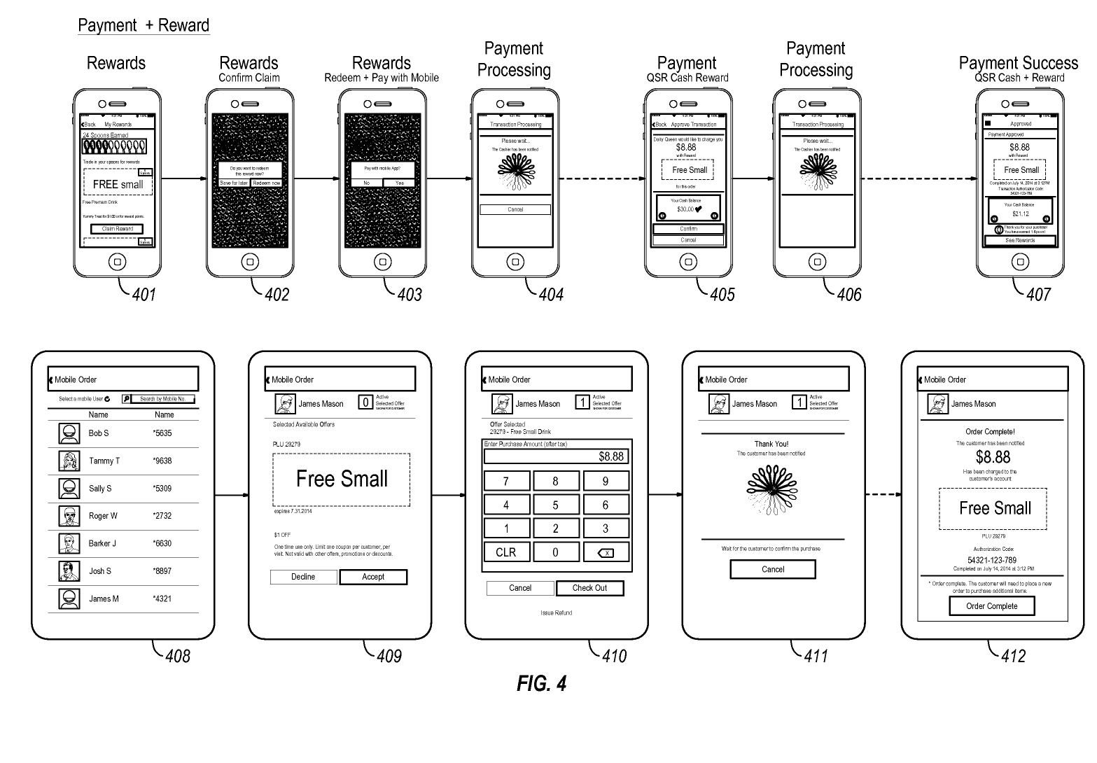

As shown in FIG. 4, users can receive loyalty points for any type of engagement with the store by the cashiers giving them points directly. These points can later be converted into rewards, which can be immediately reused at each store. The points may also be used to reduce the transaction amount, prior to debiting the user's SVA. In this example use case, the consumer enters a QSR location with registered geo coordinates. The mobile device of the consumer is comprised of the QSR mobile payment application. The mobile payment application uses the geo services of the mobile device to determine the current location of the user and use the current location to check into the store that corresponds to the registered geo coordinates.

As soon as the consumer (James M.) is recognized by the system as being within the geo coordinates of the registered QSR location, the system is operable to refresh a display of checked in consumers on a tablet device of the merchant as shown using UI 408. Referring back to FIG. 2 and using user interface UI 201, the user is presented with various options including: redeem rewards, pay with phone, use an offer, or wait for your reward point. In this example use case the customer selects the “redeem rewards” option. Responsive to the input of the consumer, the system is operable to render UI 401 on the mobile device of the consumer.

In this example use case, the consumer selects the “claim” option of the rendered UI 401 causing the system to render UI 402. Next, using UI 402 the system is operable to ask the consumer to “confirm the claim” wherein loyalty points are redeemed as a reward. Responsive to the consumer's selection of “redeem now”, the system is operable to ask the consumer if they would like to ‘pay with mobile’ for the current order. In this example use case, the consumer agrees to pay with mobile by selecting ‘yes’ on the rendered UI 403. Responsive to the input of the consumer, the system is operable to render UI 404 on the mobile device of the consumer. Control is now passed to the tablet device of the merchant. Note that the passing of control from the mobile device of the consumer to the tablet device of the merchant is more fully described in FIG. 8 as an embodiment of the Checkin Surround 804 system acting as a state machine that is operable to track all of the interactions between a plurality of consumers and merchants. The employee of merchant selects “James M.” from the display on UI 408 which causes the system to render UI 409 on the tablet. Using UI 409, the employee of the merchant “accepts” the reward presented from the mobile device of the consumer.

Next, using UI 410, the employee of the merchant enters the net tender amount ($8.88) of the purchase. It should be noted that, in some embodiments, the system is operable to automatically determine the net tender amount owed through an optional interface with the primary store order management platform. The employee of the merchant continues the process by selecting the “Checkout” option on UI 410. Responsive to the input on the tablet device, the system is operable to render UI 405 on the mobile device of the consumer. UI 405 displays the net tender amount after applying the value of the redeemed reward and the consumer's current SVA balance. The consumer can either cancel or confirm the order. In this example use case, the user confirms the order using UI 405. Responsive to the input of the consumer, the system is operable to deduct the tender amount from the SVA available balance and remove the redeemed loyalty points from the list of available loyalty points for this consumer.

During payment processing the system is operable to render UI 406 on the mobile device of the consumer and UI 411 on the tablet device of the merchant, both UIs indicting that payment processing is under way. After payment processing is complete, the system is operable to render UI 407 on the mobile device of the consumer and render UI 412 on the tablet device of the merchant. Both UIs indicate that the transaction is complete. UI 407 also provides an indication of the new available balance of the SVA account of the consumer. It is thus an advantage of the system to provide a frictionless in store payment process using a redeemed reward using the mobile device of the consumer and the tablet device of the merchant.

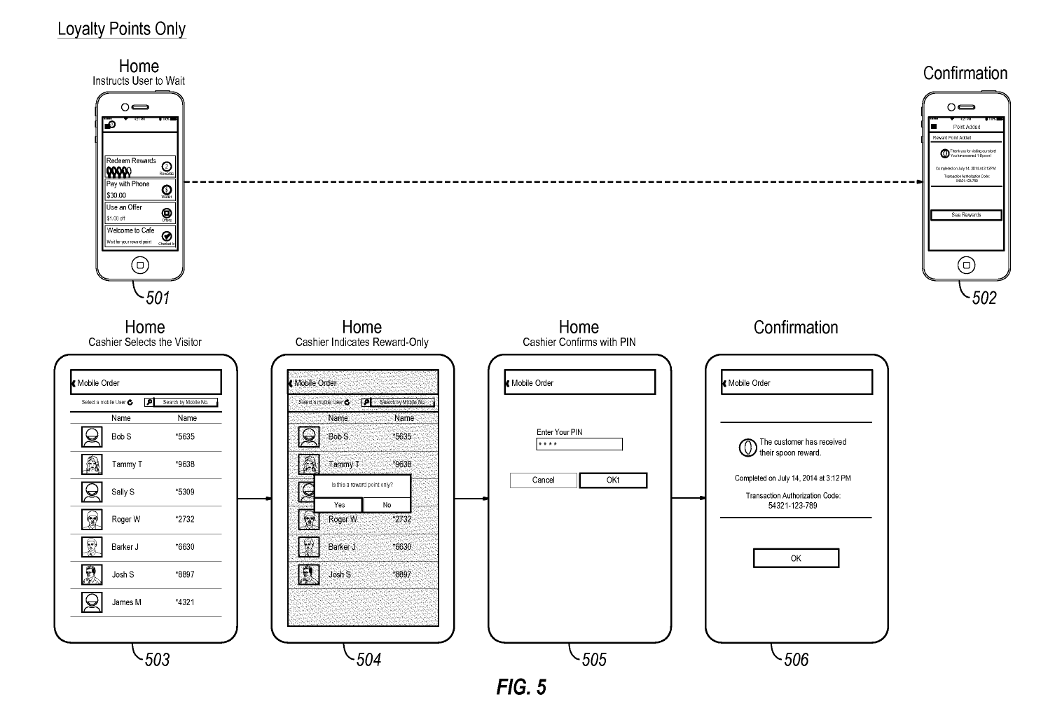

As shown in FIG. 5, customers may be able to receive loyalty points for simply being in the store. The customer may go to a store location and open their mobile wallet application. The store may use geolocation or other identification means to determine that the customer is within a specified geofence (i.e. within a certain distance from the store). Once a store manager or automated system determines the customer is within the geofence, they or the system may distribute loyalty points as desired or automatically per policy. In this example use case, the consumer enters a QSR location with registered geo coordinates. The mobile device of the consumer is comprised of the QSR mobile payment application. The mobile payment application uses the geo services of the mobile device to determine the current location of the user and use the current location to check into the store that corresponds to the registered geo coordinates.

As soon as the consumer (James M.) is recognized by the system as being within the geo coordinates of the registered QSR location, the system is operable to refresh a display of checked in consumers on a tablet device of the merchant as shown using UI 503. Referring back to FIG. 2 and using user interface UI 201, the user is presented with various options including: redeem rewards, pay with phone, use an offer, or wait for your reward point. In this example use case the customer notifies the employee of the merchant of their intention to use the “wait for a reward point” option. Control is now passed to the tablet device of the merchant. The employee of merchant selects “James M.” from the display on UI 503, which causes the system to render UI 504 on the tablet. Using UI 504, the employee of the merchant provides an indication that the consumer has elected to wait to a loyalty point.

Responsive to the input on the tablet device, the system is operable to render UI 505 on the tablet device of the merchant. Using UI 505, a PIN number is input by the employee of the merchant. Responsive to the input of the employee, the system is operable to render UI 502 on the mobile device of the consumer, indicting that a loyalty point has been earned. Note that the passing of control from the tablet device of the merchant to the mobile device of the consumer is more fully described in FIG. 8 as an embodiment of the Checkin Surround 804 system acting as a state machine that is operable to track all of the interactions between a plurality of consumers and merchants. After processing is complete, the system is operable to render UI 506 on the tablet device of the merchant indicating that the transaction is complete. It is thus an advantage of the system to provide a frictionless in store process for earning a loyalty point using the mobile device of the consumer and the tablet device of the merchant.

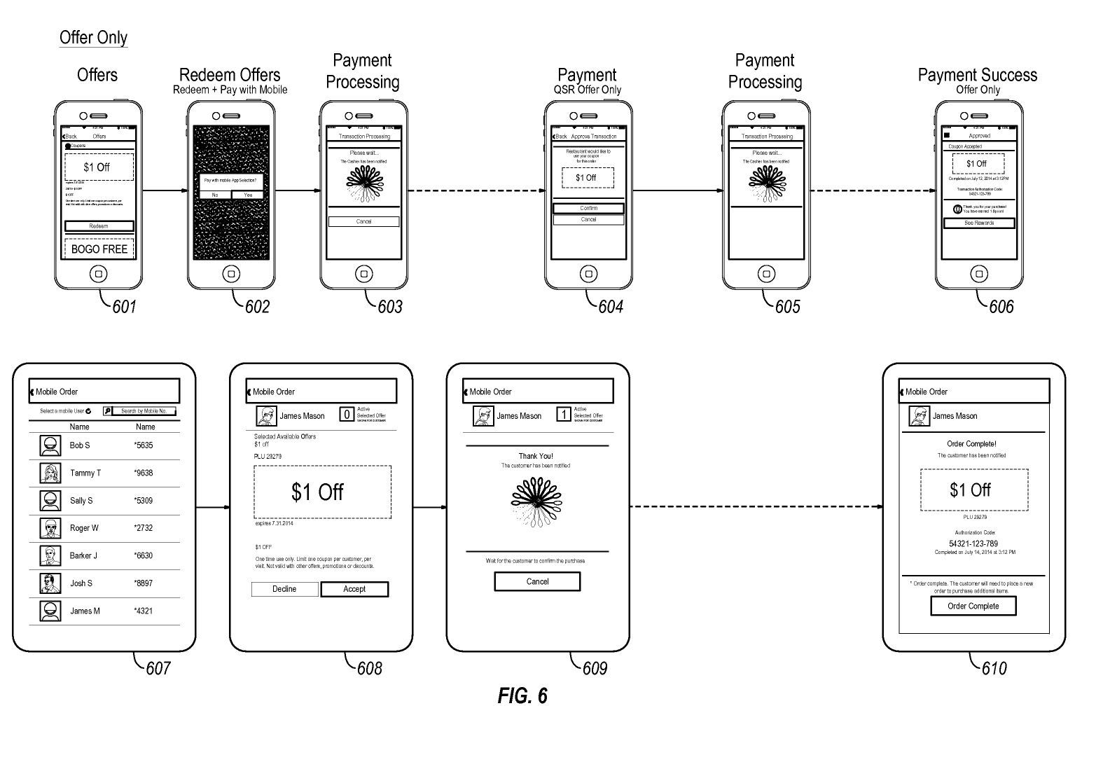

FIG. 6 illustrates an embodiment where a customer stores mobile offers in their mobile wallet application. Indeed, a customer may receive many digital coupons in their mobile wallet from a QSR or their favorite store over time. These coupons can be redeemed at any participating location by sending the offer to the cashier's tablet, at which point the offer may be validated directly in the point of sale system before processing. In this example use case, the consumer enters a QSR location with registered geo coordinates. The mobile device of the consumer is comprised of the QSR mobile payment application. The mobile payment application uses the geo services of the mobile device to determine the current location of the user and use the current location to check into the store that corresponds to the registered geo coordinates.

As soon as the consumer (James M.) is recognized by the system as being within the geo coordinates of the registered QSR location, the system is operable to refresh a display of checked in consumers on a tablet device of the merchant as shown using UI 607. Referring back to FIG. 2 and using user interface UI 201, the user is presented with various options including: redeem rewards, pay with phone, use an offer, or wait for your reward point. In this example use case the customer selects the ‘use an offer’ option. Responsive to the input of the consumer, the system is operable to render UI 601 on the mobile device of the consumer. In this example use case, the consumer selects the “redeem” option of the rendered UI 601 causing the system to render UI 602. The system is operable to ask the consumer if they would like to ‘pay with mobile’ for the current order.

In this example use case, the consumer agrees to pay with mobile by selecting “No” on the rendered UI 602. Responsive to the input of the consumer, the system is operable to render UI 603 on the mobile device of the consumer. Control is now passed to the tablet device of the merchant. Note that the passing of control from the mobile device of the consumer to the tablet device of the merchant is more fully described in FIG. 8 as an embodiment of the Checkin Surround 804 system acting as a state machine that is operable to track all of the interactions between a plurality of consumers and merchants. The employee of merchant selects “James M.” from the display on UI 607 which causes the system to render UI 608 on the tablet. Using UI 608, the employee of the merchant “accepts” the offer presented from the mobile device of the consumer causing the system to render UI 609 on the tablet of the merchant. Responsive to the input on the tablet device, the system is operable to render UI 604 on the mobile device of the consumer. UI 604 displays the value of the offer and the consumer's current but does not display the SVA balance. The consumer can either cancel or confirm the order.

In this example use case, the user confirms the order using UI 604. Responsive to the input of the consumer, the system is operable to remove the redeemed offer from the list of available offers for this consumer. During payment processing the system is operable to render UI 605 on the mobile device of the consumer. UI indicting that payment processing is under way. After payment processing is complete, the system is operable to render UI 606 on the mobile device of the consumer and render UI 610 on the tablet device of the merchant. Both UIs indicating that the transaction is complete. UI 606 also provides an indication that the coupon has been accepted. It is thus an advantage of the system to provide a frictionless in store coupon redemption process using an offer using the mobile device of the consumer and the tablet device of the merchant.

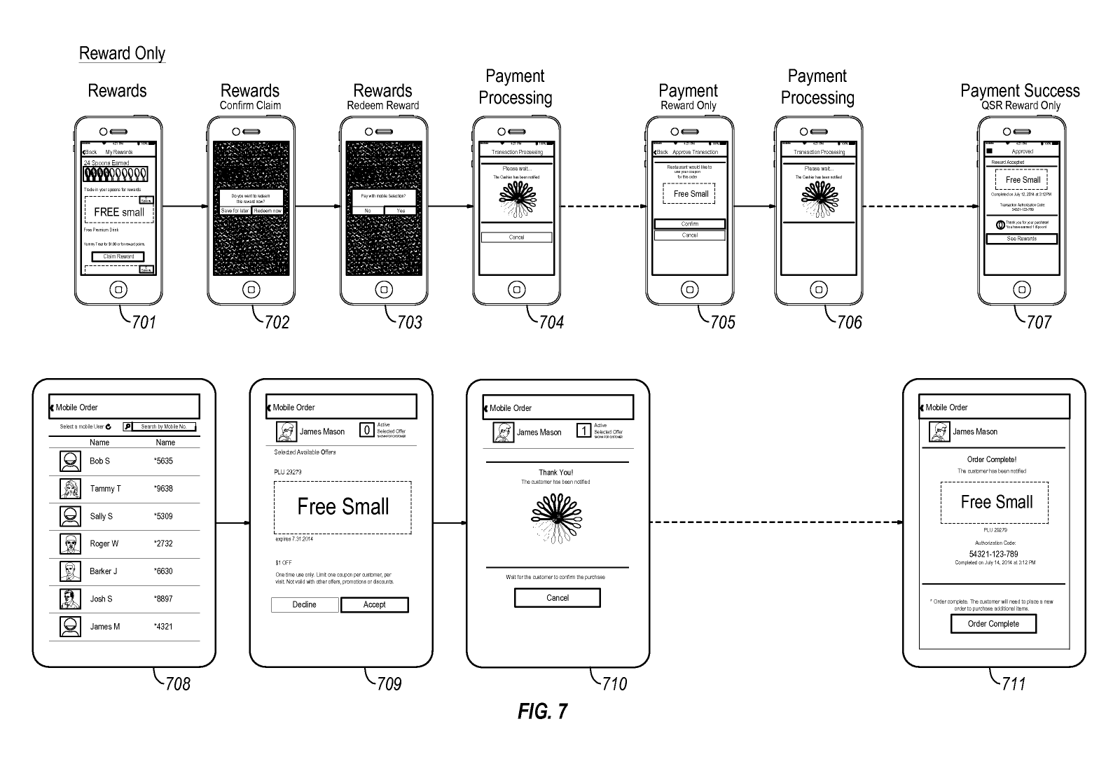

FIG. 7 describes an embodiment where customers may accrue loyalty or rewards points over time and later convert them into price discounts. As customers earn reward points and convert them into rewards, the customers may apply the rewards to reduce the price of items or services at any time. Many rewards maintain the “no purchase necessary” disclaimer, allowing customers the ability to send them to any participating location for digital processing at the cashier's station. In this example use case, the consumer enters a QSR location with registered geo coordinates. The mobile device of the consumer is comprised of the QSR mobile payment application. The mobile payment application uses the geo services of the mobile device to determine the current location of the user and use the current location to check into the store that corresponds to the registered geo coordinates.

As soon as the consumer (James M.) is recognized by the system as being within the geo coordinates of the registered QSR location, the system is operable to refresh a display of checked in consumers on a tablet device of the merchant as shown using UI 708. Referring back to FIG. 2 and using user interface UI 201, the user is presented with various options including: redeem rewards, pay with phone, use an offer, or wait for your reward point. In this example use case the customer selects the “redeem rewards” option. Responsive to the input of the consumer, the system is operable to render UI 701 on the mobile device of the consumer.

In this example use case, the consumer selects the “claim” option of the rendered UI 701 causing the system to render UI 702. Next, using UI 702 the system is operable to ask the consumer to “confirm the claim” wherein loyalty points are redeemed as a reward. Responsive to the consumer's selection of “redeem now”, the system is operable to ask the consumer if they would like to ‘pay with mobile’ for the current order. In this example use case, the consumer agrees to pay with mobile by selecting ‘no’ on the rendered UI 703. Responsive to the input of the consumer, the system is operable to render UI 704 on the mobile device of the consumer. Control is now passed to the tablet device of the merchant. As noted above, the passing of control from the mobile device of the consumer to the tablet device of the Merchant is more fully described in FIG. 8 as an embodiment of the Checkin Surround 804 system acting as a state machine that is operable to track all of the interactions between a plurality of consumers and merchants.

The employee of merchant selects “James M.” from the display on UI 708 which causes the system to render UI 709 on the tablet. Using UI 709, the employee of the merchant “accepts” the reward presented from the mobile device of the consumer. Responsive to the input on the tablet device, the system is operable to render UI 705 on the mobile device of the consumer. UI 705 displays the net tender amount after applying the value of the redeemed reward and the consumer's current SVA balance. The consumer can either cancel or confirm the order. In this example use case, the user confirms the order using UI 705. Responsive to the input of the consumer, the system is operable to remove the redeemed reward loyalty points from the list of available points for this consumer. During payment processing the system is operable to render UI 706 on the mobile device of the consumer indicting that payment processing is under way.

After payment processing is complete, the system is operable to render UI 707 on the mobile device of the consumer and render UI 711 on the tablet device of the merchant, both UIs indicating that the transaction is complete. UI 707 also provides an indication that the reward has been redeemed. It is thus an advantage of the system to provide a frictionless in store process for redeemed a reward using the mobile device of the consumer and the tablet device of the merchant.

Referring now with FIG. 8. FIG. 8 is an end-to-end sequence diagram of the system transaction flow between components in an example use case wherein a customer uses a mobile device to check in to a store and make a purchased using a deployed mobile payment application comprised of a Customer Phone (801), Cashier Tablet (802), Store Surround (803), Checkin Surround (804), MoTeaf platform (805), Notification Cloud (806), Loyalty platform (807), and Coupon platform (808). The MoTeaf platform is previously described as the Platform Functional Architecture of FIG. 1. It will be appreciated throughout this description that the Checkin Surround (804) acts as a state machine to control the primary interactions between the mobile device of the consumer and the tablet device of the merchant.

Step 8.01—Consumer uses deployed application on Phone (801) to login to MoTeaf platform (805) using secret credentials. Step 8.02—MoTeaf platform (805) having validated the credentials of the consumer using Authorization Services (107) and Security Services (106), returns a validation message comprised of a session token to Phone (801). Step 8.03—The session token is cached by the deployed application on the Phone (801). Step 8.04—Phone (801) is operable to ask the Store Surround (803) for a current list of stores, request made with the cached session token. Step 8.05—The Store Surround (803) returns a list of stores to the application deployed to the Phone (801).

Step 8.06—The application deployed on Phone (801) requests a current list of coupons available for this consumer, request sent to MoTeaf (805). Step 8.07—MoTeaf (805) uses one of Service Connectors (103) to initiate a request for available coupons from Coupon Platform (808), request including at least an indicator of the consumer. Step 8.08a—Coupon Platform (808) responsive to the request, returns a list of coupons available for the consumer. Step 8.08b—MoTeaf Platform (805) forwards the list of coupons to the Phone (801) using one of available channels in the Integration Tier (101). Step 8.09—The application deployed on Phone (801) caches the list of coupons in a local storage of the Phone.

Step 8.10—The application deployed on Phone (801) requests balances from the MoTeaf Platform (805). Step 8.11—The MoTeaf (805) platform uses an available Service Connector (103) to request the current loyalty balance, request including at least an indicator of the consumer. Step 8.12—The Loyalty Platform (807) returns the loyalty point balance of the consumer to the MoTeaf Platform (805). Step 8.13—The MoTeaf Platform (805) determines the balance of the SVA account of the consumer using Database (108) Money Container node. Step 8.14—The MoTeaf Platform (805) returns both the loyalty point balance and the SVA balance to the application deployed on the Phone (801) message sent using an available channel of the Integration Tier (101).

Step 8.15—The application deployed on the Phone (801) caches the loyalty point balance of the consumer in local memory of the device. Step 8.16—The application deployed on the Phone (801) caches the SVA balance of the consumer in local memory of the device. FIG. 8 Continued (Page 2) Step 8.17—The application deployed on the Phone (801) iterates through a list of stores previously cached to determine if the Phone is currently within a registered geo-fence associated with a listed store, registered geo-coordinates of each store also locally cached. Step 8.18—The application deployed on the Phone (801) determines that the current location of the Phone is within a predetermined distance (e.g. such as 50 feet, 100 feet) from the geo-coordinates of a cached store.

Step 8.19—Responsive to a positive match from the previous step, the consumer provides an indication to the application deployed on the Phone (801) of their intention to check in to this store. Phone (801) forwards request to the Checkin Surround (804). Note—in other example embodiments, the application can also be configured to automatically check into a store upon a positive match based on geo coordinates. Step 8.20—Checkin Surround (804)—responsive to the message marks the user as checked into this store. Step 8.21—The Checkin Surround (804) returns a message to Phone (801) indicating that the check in is successful. Step 8.22—The tablet device of the merchant is operable to periodically poll the Checkin Surround (804) for a list of customers that are checked into the store. This request is based on a set time interval and not directly tied to the previous step.

Step 8.23—Responsive to the request from the tablet, the Checkin Surround (801) returns a list of customers currently checked into this store location, request cached on the Tablet (802). Step 8.24—The employee (cashier) of the merchant uses the Tablet (802) to select a consumer from the cached list. FIG. 8 Continued (page 3) Step 8.25—The application deployed on the Tablet (802) initiates a payment request message comprised of the total ticket amount and at least an indicator of the consumer. Step 8.26—The Checkin Surround (804) responsive to the message forwards the payment request message to the Notification Cloud (806).

Step 8.27—The Notification Cloud (806) forwards the payment request message to the Phone (801). Step 8.28—In an optional embodiment, the application deployed on the Phone (804) is operable to check for pending payment request messages from the Checkin Surround (804). Step 8.29—Responsive to the request of the previous step, the Checkin Surround (804) returns a pending payment request message to the Phone (801). FIG. 8 Continued (Page 4) Step 8.30—Responsive to the pending payment message the customer uses the application deployed on the Phone (801) to approve the total, message sent to the MoTeaf Platform (805). Step 8.31—The MoTeaf Platform (805) is operable to update the SVA balance of the consumer using the Database Component (108), Money Container node.

Step 8.32—The MoTeaf Platform (805) is operable to add loyalty points to the loyalty account of the consumer based on the transaction type, using the Business Process Services layer (104). Step 8.33—The MoTeaf Platform (805) is operable to send a message to the Loyalty Platform (806) using an available Service Connector (103). Step 8.34—The Loyalty Platform (806) is operable to return a message to MoTeaf (805) with an indication that the transaction was successful. Step 8.35—MoTeaf (805) sends a payment completed message to the Checkin Surround (804). Step 8.36—MoTeaf (805) sends a message to Phone (801) with a receipt including the new available SVA balance.

FIG. 8 Continued (Page 5) Step 8.37—In an alternative embodiment meant to improve user experience, the application deployed on the Phone (801) can check the payment status on the Checkin Surround (804). Step 8.38—Responsive to the alternative step, the Checkin Surround (804) can send the payment status to the Phone (801) with an indication that the payment is complete. Step 8.39—The application deployed on the Phone (801) responsive to the payment receipt is operable to update the current display of loyalty points on the UI of the mobile application. Step 8.40—Periodically based on a predetermined time interval, the application deployed on the Tablet device of the merchant queries the Checkin Surround (801) to determine the status of all pending payments. Step 8.41—The Checkin Surround (804) returns a message with the current status of all pending payments of consumers that are currently checked into this store.

Step 8.42—The application deployed on the Phone (801), having received an indication of a completed payment, checks the customer out thus completing the transaction flow. Step 8.43—The Checkin Surround (804) returns a message to the Phone indicating that the transaction was successful. FIG. 8 Continued (Page 6) Step 8.44—The Phone (801) checks into a store in accordance with previously disclosed embodiments. Step 8.45—The Tablet (801) polls the Checkin Surround (804) for a list of consumers. Step 8.46—The employee (cashier) of the merchant uses the application deployed on the Terminal (802) to initiate a refund. Step 8.47—The application deployed on the Tablet (802) initiates a refund message. Step 8.48—The Checkin Surround (804) forwards the refund message to the Notification Cloud (806).

Step 8.49—Notification Cloud (806) forwards refund notification to Phone (801). Step 8.50—In an alternative embodiment meant to improve user experience, the application deployed on the Phone (801) can check the refund status on the Checkin Surround (804). Step 8.51—Responsive to the alternative step, the Checkin Surround (804) can send the refund status to the Phone (801) with an indication that the refund is complete. Step 8.52—Phone (801) sends message to MoTeaf (805) with an indication that the refund total amount is correct. Step 8.53—MoTeaf (805) updates the SVA balance of the consumer. Step 8.54—MoTeaf (805) sends a message to Checkin Surround (804) indicating that the refund is complete. Step 8.55—MoTeaf (805) sends a receipt with new SVA balance to Phone (801).

FIG. 8 Continued (Page 7) Step 8.56—In an alternative embodiment meant to improve user experience, the application deployed on the Phone (801) can check the refund status on the Checkin Surround (804). Step 8.57—Responsive to the alternative step, the Checkin Surround (804) can send the refund status to the Phone (801) with an indication that the refund is complete. Step 8.58—Having received a message that the refund is complete, the application deployed on the Phone (801) updates the available balance on the local cache. Step 8.59—Periodically based on a predetermined time interval, the application deployed on the Tablet device of the merchant queries the Checkin Surround (804) to determine the status of all pending refunds.

Step 8.60—The Checkin Surround (804) returns a message with the current status of all pending payments of consumers that are currently checked into this store. Step 8.61—The application deployed on the Tablet (802), having received an indication of a completed payment, checks the customer out thus completing the refund transaction flow. Step 8.62—The Checkin Surround (804) returns a message to the Phone indicating that the transaction was successful. Step 8.63—The application deployed on the Phone (801) checks into the store. In accordance with previous descriptions of this process. Step 8.64—The application deployed on the Tablet (802) periodically polls the Checkin Surround (804) for a list of customers. Step 8.65—The employee (cashier) of the merchant selects a customer form the available list to receive a partial refund (constituting a partial payment).

Step 8.66—The application deployed on the Tablet (802) initiates a refund message. Step 8.67—The Checkin Surround (804) forwards the refund message to the Notification Cloud (806). Step 8.68—Notification Cloud (806) forwards refund notification to Phone (801). FIG. 8 Continued (Page 8) Step 8.69—In an alternative embodiment meant to improve user experience, the application deployed on the Phone (801) can check the refund status on the Checkin Surround (804). Step 8.70—Responsive to the alternative step, the Checkin Surround (804) can send the refund status to the Phone (801) with an indication that the refund is complete. Step 8.71—Phone (801) sends message to MoTeaf (805) with an indication that the refund total amount is correct. Step 8.72—MoTeaf (805) updates the SVA balance of the consumer.

Step 8.73—MoTeaf (805) sends a message to Checkin Surround (804) indicating that the refund is complete including the original amount and confirmed amount. Step 8.74—MoTeaf (805) sends a receipt with new SVA balance, original amount, and confirmed amount to Phone (801). Step 8.75—In an alternative embodiment meant to improve user experience, the application deployed on the Phone (801) can check the refund status on the Checkin Surround (804). Step 8.76—Responsive to the alternative step, the Checkin Surround (804) can send the refund status to the Phone (801) with an indication that the refund is complete.

FIG. 8 Continued (Page 9) Step 8.77—The application deployed on the Phone (801) updates the balance in the local cache. Step 8.78—The application deployed on the Phone (801) displays the pending amount due to the user in the receipt. Step 8.79—Periodically based on a predetermined time interval, the application deployed on the Tablet device of the merchant queries the Checkin Surround (801) to determine the status of all pending refunds. Step 8.80—The Checkin Surround (804) returns a message with the current status of all pending payments of consumers that are currently checked into this store. Step 8.81—The application deployed on the Tablet (802), having received an indication of a completed payment, checks the customer out thus completing the refund transaction flow. Step 8.82—A message is sent from the Checkin Surround (804)) to the Tablet (802).

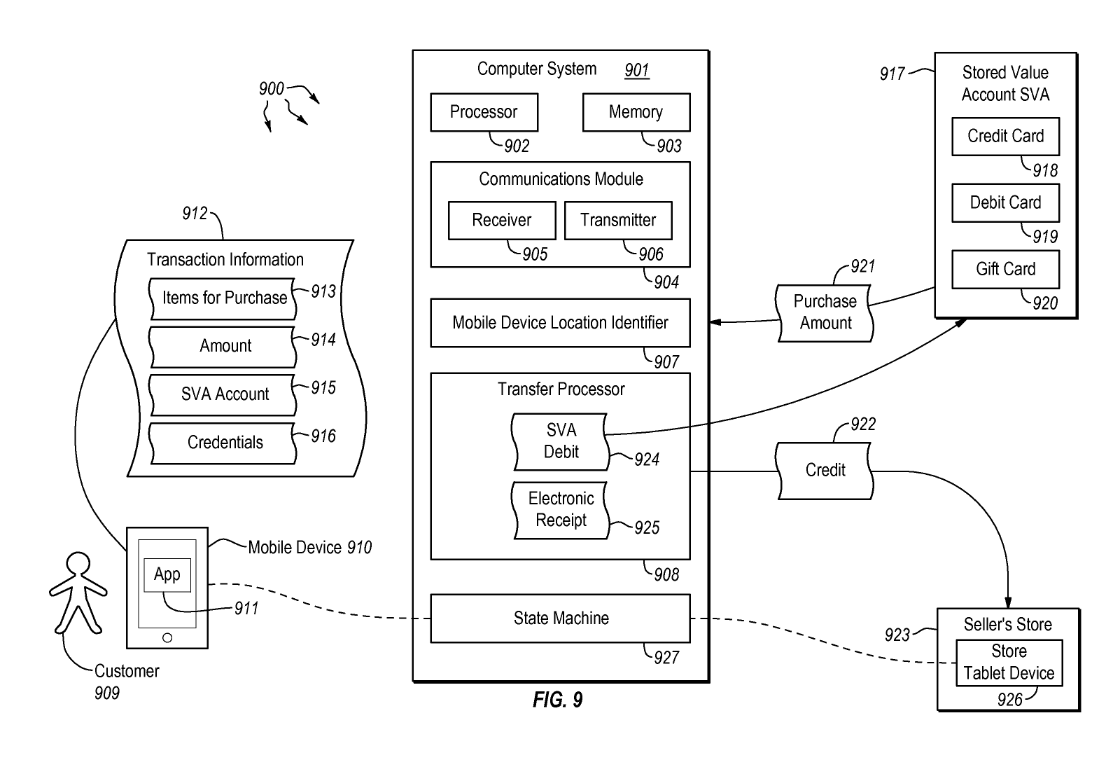

FIG. 9 illustrates an embodiment of a computing architecture 900 in which embodiments described herein may operate. In one embodiment, a computer system 901 is provided which includes a hardware processor 902, memory 903, and a communications module 904. The communications module 904 includes at least one hardware receiver 905 (such as a WiFi, Bluetooth or GPS radio receiver), and at least one hardware transmitter 906 (such as a Wifi, Bluetooth or GPS radio transmitter). In some cases, the receiver and transmitter may be combined in a transceiver.

The computer system 901 further includes a mobile device location identifier 907 configured to determine that a mobile device 910 associated with an identified customer 909 is within a specific geographic location corresponding to a seller's store. For example, a retail location may broadcast a WiFi signal which is power-limited to a given radius. Within that radius, user 909's mobile device 910 may connect to that WiFi access point. If the user's device is connected to the WiFi access point, it can be determined that the user is within a specified distance of the access point. Additionally or alternative, a GPS radio on the user's mobile device may be used to determine the user's geographic coordinates. Using these coordinates, the mobile device location identifier 907 may be able to determine that the user is within an established geofence indicating proximity to the seller's retail location 923. Other methods of identifying a user's location using cell towers or other technology may also be used.

The receiver 905 of the computer system 901 may be configured to receive transaction information 912 from a mobile wallet application 911 associated with the customer 909. The transaction information includes an indication of items that are to be purchased 913, an indication of the amount that is to be paid 914, and an indication that payment is to be made from a specific form of stored value 915 in the customer's SVA 917. The transaction information 912 may also include information that identifies the customer 909 including authentication credentials 916, or simply a name or other identifier. Using this identifier, the transaction processor 908 may identify the customer and access any stored information they may have corresponding to the user (such as previous purchase history, loyalty points, preferences or other information).

The computer system's transaction processor 908 may be a general purpose processor (such as processor 902), or may be a special purpose processor that includes embedded code designed specifically to perform the tasks of the transaction processor. The transaction processor 908 may be configured to perform the following: determine, based on the identity of the customer, the customer's current location, and the received transaction information, that the customer has approved the transaction, process the transaction using the received transaction information, such that the indicated amount that is to be paid is debited 924 from the customer's SVA, provide a credit 922 to the seller in the amount debited from the customer's SVA, and generate an electronic receipt 925 for the customer, notifying the customer that the seller has received the specified amount of money 921 from the customer's SVA.

In some cases, determining that the mobile device associated with the identified customer is within a specific geographic location corresponding to a seller's store further comprises sending a global positioning system (GPS) location query to the mobile device 910 and receiving a GPS location reply from the mobile device indicating the current GPS coordinates of the mobile device. The location reply may be a onetime reply, or may be updated continually once the user has entered the geofence. For instance, the retailer may desire to know which parts of the store the user frequents so as to provide personalized coupons or discounts for items that are located in that part of the store. The retailer may also desire to know how long the customer is at the store and how frequently they visit the store. All of this information can be tracked using the customer's current location with each interaction between the consumer mobile device 910 and store tablet device 926 controlled by state machine 927. Again, it will be understood by one skilled in the art, that substantially any type of radio signal may be used in the location query in order to determine that the mobile device is within a specified range of the geographic location of the seller's store 923.

Along with the user's current location, the transaction processor 908 may use the customer's identity to determine whether a given transaction is approved by the customer 909. For example, the customer may provide an indication of their identity such as their name or other identification information to the retailer. This identification information may be associated with the customer's mobile device information and stored in a database. Then, on subsequent visits to the seller's retail location 923, the computer system 901 will recognize the user. In some cases, the customer may further send authentication credentials 916 along with the transaction information. The authentication credentials may be used to identify the customer and verify that they are authentic.

The customer may also indicate in the transaction information, or in a previous communication with the computer system 901, that transactions with that retailer are generally permitted, especially if the user's mobile device is in the seller's store. For instance, the combination of the customer's presence in the store and the customer's prior relationship with the seller may, in some cases, be sufficient to allow a transaction. Thus, a retailer may establish relationships with customers, such that upon entering the retail location, the retailer knows who the customer is, and knows that transactions with that customer will be approved based on the established relationship along with the user's presence in the store. In other cases, authentication credentials may be used on top of these indicators to let the computer system 901 know that the transaction is (or will be) approved.

When processing the transaction, the transaction processor 908 may also determine that various discounts or loyalty points are to be applied to the customer's transaction to reduce the amount of the transaction. As explained above, the customer may have purchased products or services from the seller previously, or may receive points or discounts simply for visiting the seller's store. Regardless of how the points or discounts are obtained by the user, the transaction processor 908 may apply these discounts or loyalty points to the transaction to reduce the amount of the transaction by a specified amount. In some cases, determining which discounts or loyalty points are to be applied to the customer's transaction includes looking at the customer's purchasing history. The customer's purchasing history may, for example, indicate to the transaction processor 908 that the customer qualifies for one or more discounts or loyalty points based on their purchasing history. If such a discount applies, the reward points or coupons are applied to the transaction to reduce the transaction amount according to the number of reward points or coupon redeemed.

When the mobile wallet application 911 sends the transaction information 912 to the computer system 901, the transaction information may include a token in lieu of credit card information 918, debit card information 919 or gift card information 920 associated with the customer's SVA 917. The token may identify the customer 909, the transaction, and the SVA, without transferring any credit or debit card information. Thus, the safety of the transaction may be increased as potentially sensitive information is not transferred. The token may be encrypted, and may only be decipherable by the computer system 901 and/or other trusted computing systems. The token may point to a stored credit card account 918, debit card account 919, gift card account 920 or other form of stored value, but does not include the actual account number. The computer system 901 can access the token, determine which SVA to use for the transaction, and conduct the transaction using the stored account number.

In this manner, a customer may be able to make purchases without the seller having to provide quick response (QR) code scanners, near field communication (NFC) devices or anything other than a tablet and an internet connection. Moreover, the transaction may be frictionless and conducted without swiping a credit card or other type of card. Rather, the customer can simply open their mobile wallet application (which may be store-specific), indicate that they wish to pay for the item(s) and, based on the customer's location and previous relationship with the seller (i.e. with computer system 901), the transaction will be carried out. The computer system 901 need not be a desktop, laptop or tablet, but could be a wireless router with internet connectivity. Potentially, the router could have some type of local storage, but may opt instead for remote storage that is accessible over an encrypted connection. The router may include the transaction processor 908 in addition to or as an alternative to any existing processors used for routing data packets.

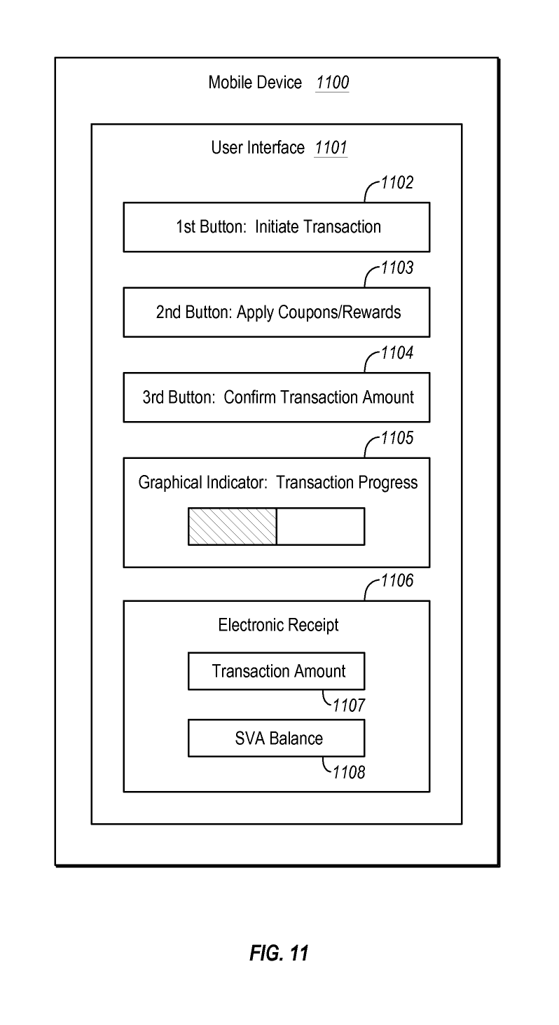

Customers may interact with the computer system 901 using mobile wallet application 911. The mobile wallet application is displayed on a display of the mobile device 1100 of FIG. 11. The display shows a user interface (UI) 1101 of the mobile wallet application. One embodiment of the UI 1101 includes the following as generally shown in FIG. 11: a first button 1102 that, when selected, initiates a transaction with a mobile payment platform (e.g. 901 of FIG. 9). The transaction initiation includes transmitting transaction information 912 to the mobile payment platform including an indication of items or services that are to be purchased 913, an indication of the amount that is to be paid 914, an indication a customer's current location, and an indication that payment is to be made from an SVA 917 associated with the customer.

The UI 1101 may also include a second button 1103 that, when selected, applies a coupon, an offer or rewards points to reduce the amount of the transaction, and a third button 1104 that, when selected, confirms that the transaction amount is to be debited from the customer's stored value account upon the mobile payment platform determining, based on the identity of the customer, the customer's current location, and the received transaction information, that the customer has approved the transaction. The UI further includes a graphical indicator 1105 indicating that the transaction is currently being processed, and an electronic receipt 1106 indicating that the transaction amount 1107 was debited from the user's stored value account.

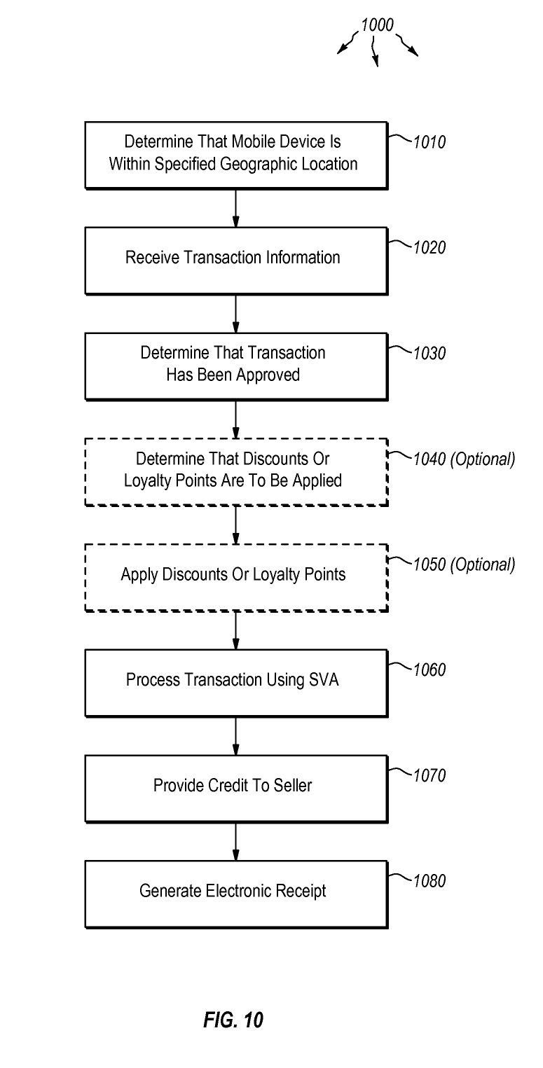

The UI may further include additional elements such as a graphical indicator that shows the customer's current stored value account balance 1108. The SVA balance may show the balance for each credit card, debit card, prepaid card, gift card or other account in the user's SVA account. Optionally, the user interface may further include a fourth button that, when selected, allows the customer to add value to their stored value account using a credit card, debit card or other card or means for transferring value. The may also include a button that, when selected, provides the customer a coupon, an offer or loyalty points that may be used when conducting a transaction. These concepts will be explained further below with regard to method 1000 FIG. 10.

In view of the systems and architectures described above, methodologies that may be implemented in accordance with the disclosed subject matter will be better appreciated with reference to the flow chart of FIG. 10. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter

FIG. 10 illustrates a flowchart of a method 1000 for performing a transaction using a stored value account. The method 1000 will now be described with frequent reference to the components and data of environment 900 of FIG. 9 and the user interface of FIG. 11.

Method 1000 includes determining that a mobile device associated with an identified customer is within a specific geographic location corresponding to a seller's store (1010). For example, the mobile device location identifier 907 may identify mobile device 910's current location. This may be done using a variety of different wireless technologies including WiFi, Bluetooth, GPS or others. The mobile device 910 may thus communicate with computer system 901 to determine where the mobile device is or, more specifically, whether the mobile device is within a specified geofence.

Method 1000 further includes receiving transaction information from a mobile wallet application associated with the customer, where the transaction information includes an indication of one or more items that are to be purchased, an indication of the amount that is to be paid, and an indication that payment is to be made from a stored value account (SVA) associated with the customer (1020). The transaction processor 908 then determines, based on the identity of the customer, the customer's current location, and the received transaction information, that the customer has approved the transaction (1030). For example, the customer may agree via the mobile wallet application that whenever they are within the limits of the seller's store 923, and whenever they apply a PIN or other credential within their mobile wallet application 911, they approve transactions with that seller based on their relationship with the seller.

Accordingly, on the seller's side, once a known, identified customer attempts to make a purchase using the (store-specific) mobile wallet application and the customer is within the geofence, the transaction may be carried out without the user swiping a card or signing anything. Rather, the user can simply enter a PIN or use their fingerprint on their mobile device via the mobile wallet application and purchase the desired product or service.

Method 1000 next includes an optional act of determining that one or more discounts or loyalty points are to be applied to the customer's transaction to reduce the amount of the transaction (1040). For example, if discounts or points are available to the customer, and if the customer has indicated a desire to used the discounts, then they may be applied to the transaction to reduce the amount of the transaction by a specified amount (1050). The transaction processor then process the transaction at the specified amount or the reduced amount (after discounts are applied) using the received transaction information, such that the indicated amount that is to be paid is debited from the customer's SVA 917 (1060).

Method 1000 further includes providing a credit 922 to the seller in the amount debited 921 from the customer's SVA 917 (1070), and generating an electronic receipt 925 for the customer, notifying the customer that the seller has received the specified amount of money from the customer's SVA (1080). The electronic receipt 925 may also be sent to the seller for their records. In some cases, the customer's SVA account may be specific to the seller, such that funds in the seller-specific SVA account are only valid at the seller's location(s). Such accounts may include gift card accounts, in-store credit, or prepaid debit cards specific to the seller.

In some embodiments, the computer system 901 may provide an image of the identified customer to the seller. The image may be displayed on the seller's tablet or other computing system (e.g. 901). The image may help a cashier to know that the person using the mobile device 910 that initiated the transaction is actually the customer with which the seller has established a purchasing relationship. Along with the image, other information such as the customer's name, purchase preferences, payment preferences, loyalty information or other types of useful and relevant information may be provided to the seller. In some cases, the computer system 901 may provide a list of those identified customers that are currently present at the seller's location. Thus, in this manner, a seller may be able to see a list with pictures of all of the customers currently in the store that have a purchasing relationship with the seller. This may allow a store owner or manager to make personal greeting to repeat customers or provide them with special discounts or coupons simply for being at the seller's store.

Other concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising:
a mobile device location identifier configured to determine that a mobile device associated with an identified customer is within a specific geographic location corresponding to a seller's store;
a receiver configured to receive transaction information from a mobile wallet application associated with the customer, the transaction information including an indication of one or more items that are to be purchased, an indication of the amount that is to be paid, and an indication that payment is to be made from a stored value account (SVA) associated with the customer;
a transaction processor configured to perform the following:
determine, based on the identity of the customer, the customer's current location, and the received transaction information, that the customer has approved the transaction;
process the transaction using the received transaction information, such that the indicated amount that is to be paid is debited from the customer's SVA;
provide a credit to the seller in the amount debited from the customer's SVA; and
generate an electronic receipt for the customer, notifying the customer that the seller has received the specified amount of money from the customer's SVA.

2. The computer system of claim 1, wherein determining that the mobile device associated with the identified customer is within a specific geographic location corresponding to a seller's store further comprises:
sending a global positioning system (GPS) location query to the mobile device; and
receiving a GPS location reply from the mobile device indicating the current GPS coordinates of the mobile device.

3. The computer system of claim 1, wherein determining that the mobile device associated with the identified customer is within a specific geographic location corresponding to a seller's store further comprises:
transmitting a radio signal location query to the mobile device; and
receiving a radio signal reply from the mobile device indicating the mobile device is within a specified range of the geographic location of the seller's store.

4. The computer system of claim 1, further comprising the transaction processor performing the following:
determining that one or more discounts or loyalty points are to be applied to the customer's transaction to reduce the amount of the transaction; and
applying the discounts or loyalty points to the transaction to reduce the amount of the transaction by a specified amount.

5. The computer system of claim 4, wherein determining that one or more discounts or loyalty points are to be applied to the customer's transaction to reduce the amount of the transaction comprises determining the customer's purchasing history, wherein the customer qualifies for one or more discounts or loyalty points based on the customer's purchasing history.

6. The computer system of claim 4, wherein one or more reward points are applied to the transaction to reduce the transaction amount according to the number of reward points redeemed.

7. The computer system of claim 1, wherein the transaction information received from the mobile wallet application includes a token which identifies the customer, the transaction, and the SVA.

8. The computer system of claim 1, wherein the receiver further receives one or more authentication credentials associated with the user in addition to the transaction information.

9. The computer system of claim 1, wherein the computer system comprises a wireless router with internet connectivity.

10. The computer system of claim 1, wherein the computer system allows users to make purchases without the seller providing quick response (QR) code scanners, near field communication (NFC) devices.

11. A computer system comprising:
one or more processors; and
a display that displays a user interface, the user interface providing the following:
a first button that, when selected, initiates a transaction with a mobile payment platform, the transaction initiation including transmitting transaction information to the mobile payment platform including an indication of one or more items that are to be purchased, an indication of the amount that is to be paid, an indication a customer's current location, and an indication that payment is to be made from a stored value account (SVA) associated with the customer;
a second button that, when selected, applies a coupon, an offer or rewards points to reduce the amount of the transaction;
a third button that, when selected, confirms that the transaction amount is to be debited from the customer's SVA upon the mobile payment platform determining, based on the identity of the customer, the customer's current location, and the received transaction information, that the customer has approved the transaction;
a graphical indicator indicating that the transaction is currently being processed; and
an electronic receipt indicating that the transaction amount was debited from the user's stored value account.

12. The computer system of claim 11, wherein the user interface further includes graphical indicator that shows the customer's current stored value account balance.

13. The computer system of claim 11, wherein the user interface further includes a fourth button that, when selected, allows the customer to add value to their stored value account using a credit card or a debit card.

14. The computer system of claim 13, wherein the transaction information sent to the mobile payment platform includes a token which identifies the customer, the transaction, and the SVA, such that credit card and debit card information is not transferred in the transaction information.

15. The computer system of claim 11, wherein the user interface further includes a fourth button that, when selected, provides at least one selected customer a coupon, an offer or loyalty points.

16. A computerized method, performed at computer system including at least one processor, for performing a transaction using a stored value account, the method comprising:
determining that a mobile device associated with an identified customer is within a specific geographic location corresponding to a seller's store;
receiving transaction information from a mobile wallet application associated with the customer, the transaction information including an indication of one or more items that are to be purchased, an indication of the amount that is to be paid, and an indication that payment is to be made from a stored value account (SVA) associated with the customer;
determining, based on the identity of the customer, the customer's current location, and the received transaction information, that the customer has approved the transaction;
determining that one or more discounts or loyalty points are to be applied to the customer's transaction to reduce the amount of the transaction;
applying the discounts or loyalty points to the transaction to reduce the amount of the transaction by a specified amount;
processing the transaction at the reduced amount using the received transaction information, such that the indicated amount that is to be paid is debited from the customer's SVA;
providing a credit to the seller in the amount debited from the customer's SVA; and
generating an electronic receipt for the customer, notifying the customer that the seller has received the specified amount of money from the customer's SVA.

17. The method of claim 16, wherein the customer's SVA account is specific to the seller, such that funds in the seller-specific SVA account are only valid at the seller's one or more locations.

18. The method of claim 16, further comprising providing an image of the identified customer to the seller.

19. The method of claim 16, further comprising providing loyalty information to the seller.

20. The method of claim 16, further comprising providing a list of those identified customers that are currently present at the seller's location.
